(19) United States
(12) Patent Application Publication
(10) Pub. No.: US 2020/0086434 A1
(43) Pub. Date: Mar. 19, 2020

(54) MAKING NOZZLE STRUCTURES ON A STRUCTURED SURFACE

(71) Applicant: 3M INNOVATIVE PROPERTIES COMPANY, St. Paul, MN (US)

(72) Inventors: Barry S. Carpenter, Oakdale, MN (US); Scott M. Schnobrich, Stillwater, MN (US); Jeffrey N. Bartow, West St. Paul, MN (US); Alexander J. Huffman, St. Paul, MN (US); Brian K. Nelson, Shoreview, MN (US)

(21) Appl. No.: 16/469,732

(22) PCT Filed: Dec. 21, 2017
(86) PCT No.: PCT/IB2017/058315

§ 371 Date: Jun. 14, 2019

Related U.S. Application Data
(60) Provisional application No. 62/438,561, filed on Dec. 23, 2016.

(51) Int. Cl. B23P 15/16; F02M 61/18; C25D 1/08; C25D 1/00

(52) U.S. Cl. CPC B23P 15/16; C25D 1/003; C25D 1/08; F02M 61/18

(57) ABSTRACT

Methods of manufacturing fuel injector nozzle structures such as, e.g., nozzle plates, valve guides, combinations of nozzle plates and valve guides, etc., as well as other articles incorporating microstructured features. The methods may employ multiphoton processes to form microstructured patterns on a three-dimensional structured surface to provide nozzle structures and other articles that include finished microstructured features such as, e.g., through-holes extending from one or more cavities, where at least a portion of the three-dimensional structured surface is used to form the cavities. Forming a microstructured pattern on a three-dimensional structured surface can reduce the time needed to form nozzle structures that include microstructured features and other nozzle structure features (e.g., cavities) by avoiding the need to form the other nozzle structure features using the multiphoton processes.

### FIELD OF THE INVENTION

This invention generally relates to manufacturing nozzle structures (e.g., partial or complete nozzle plates, valve guides, and other nozzle structures suitable for use in a fuel injector for an internal combustion engine, including integral combinations of such structures), as well as other articles including microstructured features. This invention also relates to making fuel injectors incorporating such nozzle structures.

### BACKGROUND

There are three basic types of fuel injector systems: port fuel injection (PFI), gasoline direct injection (GDI), and direct injection (DI). While PFI and GDI use gasoline as the fuel, DI uses diesel fuel. Efforts continue to further develop methods of manufacturing fuel injector nozzle plates, otherwise known as director plates, and fuel injection systems containing the same so as to potentially increase fuel efficiency and reduce hazardous emissions of internal combustion engines, as well as reduce the overall energy requirements of a vehicle comprising an internal combustion engine.

The fuel injector systems use fuel injector nozzles including nozzle structures with through-holes formed therethrough to deliver fuel for combustion. Manufacturing nozzle structures can pose particular challenges in systems where control over the delivery of the fuel through the nozzle structures can improve or reduce efficiency of the engines.

### SUMMARY

The present invention is directed to methods of manufacturing fuel injector nozzle structures. Such structures can include, e.g., a portion or all of a nozzle plate, valve guide, combinations of nozzle plates and valve guides, etc., as well as other articles incorporating microstructured features.

In one or more embodiments, the methods described herein employ multiphoton processes to form microstructured patterns on three-dimensional structured surfaces to provide nozzle structures (e.g., partial or complete nozzle plates, valve guides, a combination thereof, etc.) and other articles that include finished microstructured features such as, e.g., one or more through-holes, one or more through-holes extending from one or more cavities, and other nozzle structure features. The one or more cavities can be formed in the shape of a portion, most or all of the three-dimensional structured surfaces. Forming microstructured patterns on three-dimensional structured surfaces as described herein may, in one or more embodiments, reduce the time needed to form nozzle structures, including microstructured features and cavities, by avoiding the need to form the one or more cavities using the multiphoton processes. In particular, the three-dimensional structured surface can be shaped so as to form a nozzle structure feature like the one or more cavities, with the microstructured features being formed on the three-dimensional structured surface using multiphoton processing. Avoiding the need to form certain nozzle structure features (e.g., cavity shapes and/or structures) using multiphoton processes can significantly reduce the time required to manufacture nozzle structures and other articles as described herein.

In one or more embodiments, the methods of manufacturing nozzle structures as described herein may include: forming a microstructured pattern on at least a portion, most or all of a three-dimensional structured surface by multi-photon processing a first material; replicating a negative of the microstructured pattern and at least a portion, most or all of the three dimensional structured surface using a second material, different than the first material, to form a replicated structure having a negative pattern of the microstructured pattern and a negative surface of at least a portion of the three dimensional structured surface (i.e., a negative pattern/surface); separating the replicated structure from the microstructured pattern and three-dimensional structured surface (e.g., by removing the replicated structure from the three-dimensional structured surface and removing the microstructured pattern from the replicated structure).

In one or more embodiments, the method further comprises removing a portion of the second material from the replicated structure, after replicating the negative. In one or more embodiments, removing a portion of the second material from the replicated structure occurs after the replicated structure is removed from the three-dimensional structured surface.

In one or more embodiments, the three-dimensional structured surface is located on a bottom of a cavity, and the first material is located in the cavity before multi-photon processing the first material.

In one or more embodiments, the three-dimensional structured surface comprises two discrete ruled surfaces, and at least a portion of the microstructured pattern is formed on the two discrete ruled surfaces.

In one or more embodiments, the three-dimensional structured surface is electrically conductive.

In one or more embodiments, the three-dimensional structured surface comprises an insert provided as a separate and discrete article located on a support surface of the substrate. In one or more embodiments, the support surface does not form a portion of the three-dimensional structured surface. In one or more embodiments, the insert is submerged in the first material before forming a microstructured pattern on the three-dimensional structured surface in the first material. In one or more embodiments, separating the replicated structure from the three-dimensional structured surface comprises removing the insert.

In one or more embodiments, the three-dimensional structured surface comprises a portion, most or all of a fuel injector valve.

In one or more embodiments, the microstructured pattern comprises a plurality of microstructured features, and each microstructured feature is formed on the three-dimensional structured surface. In one or more embodiments, each microstructured feature of the plurality of microstructured features comprises a base formed on the three-dimensional structured surface and a distal end distal from the three-dimensional structured surface, and the microstructured pattern optionally comprises at least one support feature attached to the distal ends of at least two or more or all of the plurality of microstructured features.

In one or more embodiments, the step of replicating the replicated structure comprises electroplating the three-dimensional structured surface such that the microstructured pattern is contained within the second material.

In one or more embodiments, the microstructured pattern defines a plurality of through-holes extending through the replicated structure from an inlet face of the replicated structure to an outlet face of the replicated structure, after the replicated structure is separated from the three-dimensional structured surface and the microstructured pattern.

The above summary is not intended to describe each embodiment or every implementation of the methods of manufacturing nozzle structures or other articles as described herein. Rather, a more complete understanding of the invention will become apparent and appreciated by reference to the following Detailed Description and claims in view of the accompanying figures of the drawing.

### BRIEF DESCRIPTIONS OF THE DRAWINGS

FIG. 1 is a perspective view of one exemplary nozzle structure in the form of a nozzle plate that can be manufactured using the methods described herein.

FIG. 2 is a top view of the exemplary nozzle plate shown in FIG. 1.

FIG. 3 is a cross-sectional view of the exemplary nozzle plate shown in FIGS. 1 and 2 taken along line 3-3 in FIG. 2.

FIG. 4 is a cross-sectional view of a three-dimensional structured surface in a cavity on a substrate containing first material to begin one illustrative method of manufacturing a nozzle plate as depicted in FIGS. 1-3.

FIG. 5 depicts one exemplary embodiment of an exposure system for exposing a multi-photon material to form a microstructured pattern on a three-dimensional structured surface as described herein.

FIG. 6 depicts microstructured features forming a microstructured pattern after developing the first material in FIG. 4 to form the microstructured pattern and removing the undeveloped first material from the cavity.

FIG. 7 depicts the microstructured features forming the microstructured pattern after replicating the microstructured pattern and the three-dimensional structured surface using a second material.

FIG. 8 depicts the replicated structure formed by separating the replicated structure from the three-dimensional structured surface in the cavity of FIG. 7.

FIG. 9 depicts the replicated structure formed by the second material, after separating the replicated structure from the microstructured features of the microstructured pattern, along with broken lines depicting portions of the second material to be removed from the replicated structure to form the nozzle plate of FIGS. 1-3.

FIG. 10 is a cross-sectional view of the nozzle plate of FIG. 9 after removing portions of the second material.

FIG. 11 is a cross-sectional view of one exemplary embodiment of a fuel injector including another exemplary embodiment of a nozzle structure in the form of a nozzle plate including valve sealing surfaces that can be manufactured using methods as described herein and valve located below the nozzle structure.

FIG. 12 is a cross-sectional view of a three-dimensional structured surface in a cavity on a substrate containing first material that can be used to manufacture the nozzle plate as depicted in FIG. 11, with the microstructured features of FIG. 13 depicted in broken lines.

FIG. 13 depicts microstructured features and a support feature forming a microstructured pattern after developing the first material in FIG. 12 to form the microstructured pattern and removing the undeveloped first material from the cavity.

FIG. 14 depicts the microstructured pattern of FIGS. 12-13 after replicating the microstructured pattern and the three-dimensional structured surface using a second material.

FIG. 15 depicts the replicated structure formed by the second material along with a broken line depicting a portion of the second material to be removed from the replicated structure to form the nozzle plate depicted in FIG. 11.

FIG. 16 is a cross-sectional view of another method of manufacturing a nozzle structure in the form of a nozzle plate using an insert to provide a three-dimensional structured surface on which a microstructured pattern is formed, with the three-dimensional structured surface and the microstructured pattern replicated in a second material.

FIG. 17 is a cross-sectional view of the replicated structure, after removal from the cavity of FIG. 16, with the microstructured pattern and the three-dimensional structured surface insert.

FIG. 18 is a cross-sectional view of the replicated structure of FIG. 17, after removal of a portion of the second material, the microstructured pattern and the insert to form another exemplary embodiment of a nozzle plate as described herein.

FIG. 19 is a cross-sectional view of one illustrative embodiment of a three-dimensional structured surface having a microstructured pattern located thereon which may be used in one or more embodiments of methods as described herein to, e.g., manufacture a nozzle structure.

FIG. 20 is an end view of the three-dimensional structured surface of FIG. 19 taken in the direction of axis 511.

FIG. 21 is a cross-sectional view of one illustrative embodiment of the three-dimensional structured surface in the form of a valve in an assembly that may be used to form a nozzle structure as described herein.

FIG. 22 is a cross-sectional view of the assembly of FIG. 21 as assembled and prior to electroforming a nozzle structure using the pin 530.

FIG. 23 is a cross-sectional perspective view of one illustrative embodiment of a nozzle structure that may be manufactured using the pin of FIGS. 19-22.

FIG. 24 is an end view depicting a valve located in the cavity formed in the nozzle structure of FIG. 23.

### DETAILED DESCRIPTION

In the following description, reference is made to the accompanying figures of the drawing which form a part hereof, and in which are shown, by way of illustration, specific embodiments. It is to be understood that other embodiments may be utilized and changes may be made without departing from the scope of the present invention.

The methods of manufacturing nozzle structures or other articles as described herein can, in one or more embodiments, use multiphoton (e.g., two photon) techniques, equipment and materials described in U.S. Pat. No. 9,333,598 B2 and US Patent Application Publication No. US 2013/0313339 (both titled “Nozzle and Method of Making Same”). In particular, multiphoton processes can be used to fabricate various microstructured patterns, which can, for example, include one or more hole forming features that may be used in, e.g., one or more nozzle structures used in fuel injectors. Further, the processes can, as described herein, be used to form nozzle structures (or other articles) themselves and/or as molds that can then be used to fabricate nozzle structures or other articles.

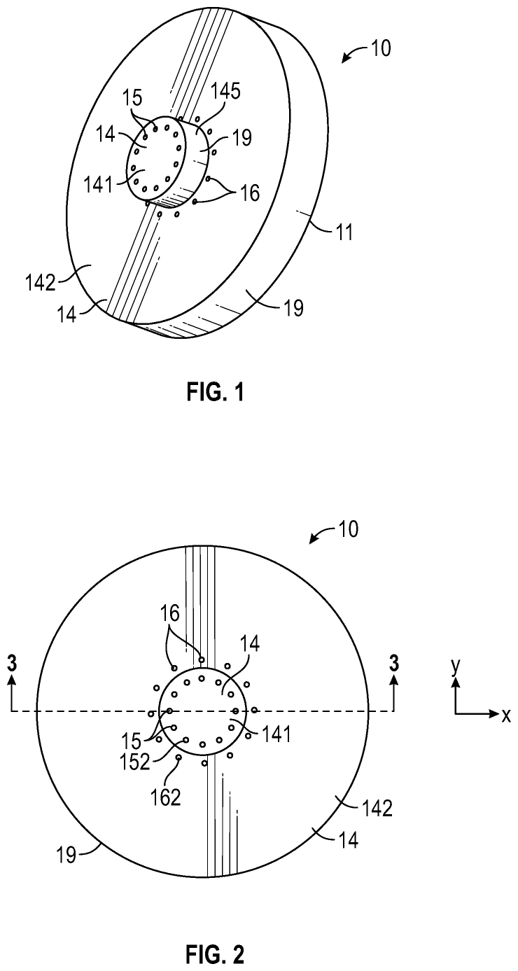

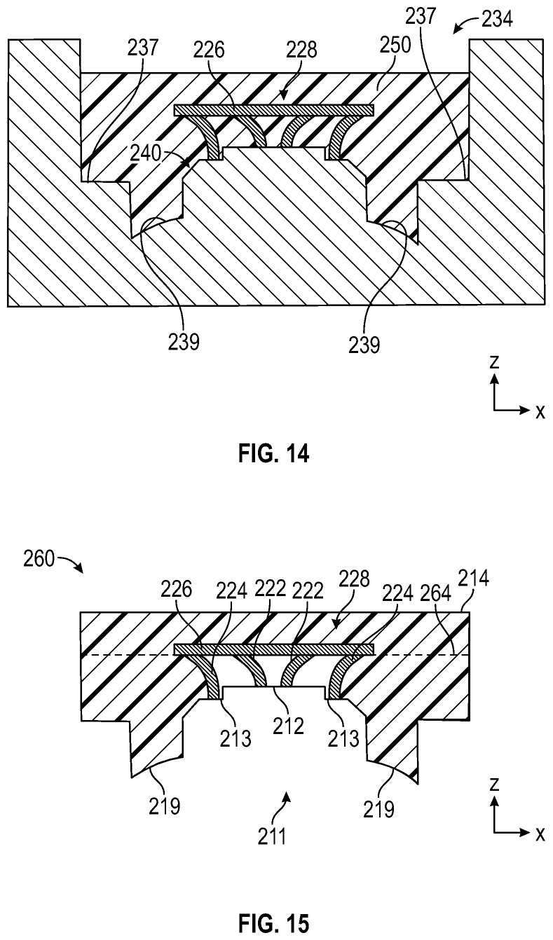

The microstructured articles described herein may, in one or more embodiments, be suitable for use as nozzle structures (including, e.g., nozzle plates, valve guides, nozzle plate and valve guide structures, and other structural combinations) used in fuel injector nozzles. It should be understood that the term “nozzle” or “nozzle structure”, as used herein, may have a number of different meanings in the art. For example, U.S. Patent Publication No. 2009/0308953 A1 (Palestrant et al.), discloses an “atomizing nozzle” which includes a number of elements, including an orifice insert 24 and an occluder chamber 50. The understanding and definition of “nozzle structure” put forth herewith may, for example, include such structure like the orifice insert 24 of Palestrant et al. along with a portion, most or all of the structure corresponding to the chamber 50. In general, the nozzle structure of the current description can be understood as including the structure of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle . . . ”—see col. 4, lines 26-27 of Ogihara et al.). The current definition and understanding of the term “nozzle structure” as used herein would relate, e.g., to first and second orifice plates 130 and 132, valve body 26, and potentially sleeve 138 (see FIGS. 14 and 15 of Ogihara et al.), for example, which are located immediately proximate the fuel spray. Similar structures that may be referred to as “nozzle structure”, as described herein, is disclosed in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1). Such separate elements may be formed, in part or completely, as one unitary structure. The above-described structures may be included when the term “nozzle structure” is referred to throughout the remainder of the description and claims.

In one or more embodiments, the nozzle structures manufactured using the methods described herein may include one or more nozzle through-holes strategically incorporated into the nozzle structure. The one or more nozzle through-holes may provide one or more of the following properties to the nozzle structure: (1) the ability to provide variable fluid flow through the nozzle (e.g., by opening or closing off one or more one or more nozzle through-holes), (2) the ability to provide multi-directional fluid flow relative to an outlet face of the nozzle structure, and (3) the ability to provide multidirectional off-axis fluid flow relative to a central normal line extending perpendicularly through the nozzle outlet face.

As discussed, the methods of manufacturing nozzle structures and other articles as described herein preferably use multiphoton processes. Although these manufacturing processes are useful for producing accurate microstructured features in a selected microstructured pattern, the time required to develop/harden the volume of material needed to form some nozzle structures or other articles can be excessive where, for example, larger features need to be provided in the finished nozzle structures or other articles.

When used to manufacture nozzle structures for fuel injectors as described herein, one example of larger features may include cavities and other shapes on the inlet face of a nozzle structure (e.g., a nozzle plate, etc.) that is configured to reduce the SAC volume when used in connection with a fuel injector valve having a complementary shape. In such embodiments, the three-dimensional structured surface may have a shape that is complementary to the shape of a valve used in connection with the nozzle structure such that the SAC volume in a fuel injector can be reduced. “SAC volume” is defined as a volume of space between an inlet face of a fuel injector nozzle (i.e., inlet face of the nozzle) and an outer surface of a valve of a fuel injector system.

FIGS. 1-3 depict various views of one exemplary structure in the form of a nozzle plate 10 manufactured using the methods described herein. The nozzle plate 10 includes a three-dimensional inlet face 11, an outlet face 14 on an opposite side of the nozzle plate from the inlet face 11, and a perimeter face 19 surrounding both the inlet face 11 and the outlet face 14. Outlet face 14 includes a first outlet surface 141 and a second outlet surface 142 surrounding the first outlet surface 141, with a sidewall 145 extending between the first outlet surface 141 and the second outlet surface 142.

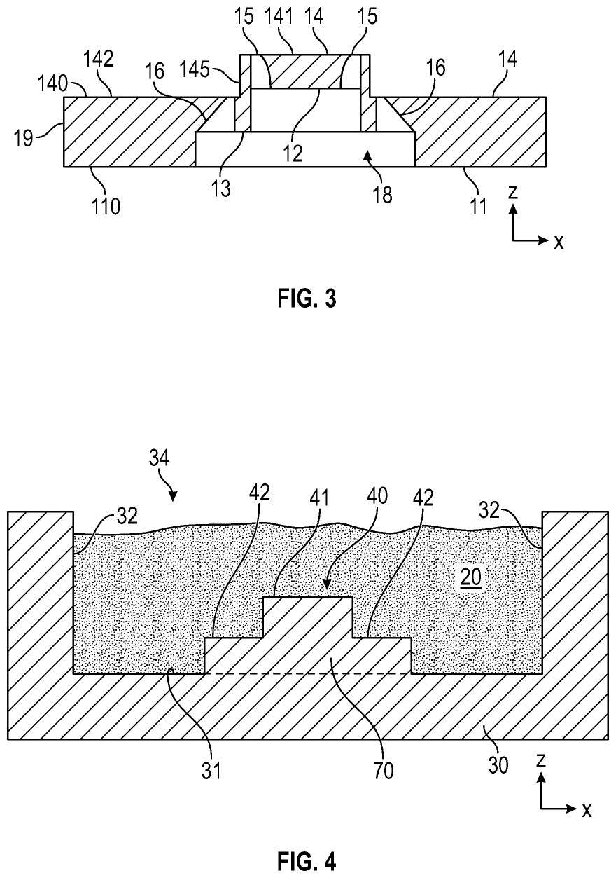

A first set of nozzle through-holes 15 is formed with outlet openings 152 in the first outlet surface 141 and a second set of nozzle through-holes 16 is formed with outlet openings 162 in the second outlet surface 142. Each first nozzle through-hole 15 includes at least one inlet opening 151 on a first inlet surface 12 on the inlet face 11, with each through-hole 15 connected to at least one outlet opening 152 on outlet face 14. Each second nozzle through-hole 16 includes at least one inlet opening 161 on a second inlet surface 13 on the inlet face 11, with each through-hole 16 connected to at least one outlet opening 162 on outlet face 14. As shown in FIG. 3, the first inlet surface 12 is not coplanar with second inlet surface 13 and both of the inlet surfaces 12 and 13 are inset from a surrounding perimeter portion 110 of the inlet face 11 such that a cavity 18 is located in the inlet face 11 of the nozzle plate 10.

The nozzle structures and other articles including microstructured patterns described herein can be manufactured using the methods described herein. One illustrative embodiment of a method for manufacturing a nozzle structure or other article such as, e.g., nozzle plate 10 depicted in in FIGS. 1-3, can be described with reference to FIGS. 4-9. The method provides flexibility and control in producing a variety of individual microstructured features such as holes, cavities, etc. in a single article.

FIG. 4 is a schematic side-view of a first material 20 disposed on a substrate 30. The substrate 30 includes sidewalls 32 to form a cavity 34 having a bottom 31. A discrete amount of the first material 20 is contained in the cavity 34. The first material 20 is capable of undergoing multiphoton reaction by simultaneously absorbing multiple photons. For example, in one or more embodiments, the first material is capable of undergoing a two photon reaction by simultaneously absorbing two photons. The first material can be any material or material system that is capable of undergoing multiphoton, such as two photon, reaction, such as those described in U.S. Pat. No. 7,583,444 (“Process For Making Microlens Arrays And Masterforms”); U.S. Patent Application Publication US 2009/0175050 (“Process For Making Light Guides With Extraction Structures And Light Guides Produced Thereby”); and PCT Publication WO 2009/048705 (“Highly Functional Multiphoton Curable Reactive Species”).

In some cases, the first material can be a photoreactive composition that includes at least one reactive species that is capable of undergoing an acid- or radical-initiated chemical reaction, and at least one multiphoton photoinitiator system. Reactive species suitable for use in the photoreactive compositions include both curable and non-curable species. Exemplary curable species include addition-polymerizable monomers and oligomers and addition-crosslinkable polymers (such as free-radically polymerizable or crosslinkable ethylenically-unsaturated species including, for example, acrylates, methacrylates, and certain vinyl compounds such as styrenes), as well as cationically-polymerizable monomers and oligomers and cationically-crosslinkable polymers (which species are most commonly acid-initiated and which include, for example, epoxies, vinyl ethers, cyanate esters, etc.), and the like, and mixtures thereof. Exemplary non-curable species include reactive polymers whose solubility can be increased upon acid- or radical-induced reaction. Such reactive polymers include, for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists.

The multiphoton photoinitiator system enables polymerization to be confined or limited to the focal region of a focused beam of light used to expose the first material. Such a system preferably is a two- or three-component system that includes at least one multiphoton photosensitizer, at least one photoinitiator (or electron acceptor), and, optionally, at least one electron donor.

The first material 20 can be supplied on the substrate 30 using any method. Higher viscosity first materials may, for example, be coated on a substrate using any coating method that may be desirable in particular situation. For example, the first material could, in one or more embodiments, be coated on a substrate by flood coating. Other exemplary coating methods include knife coating, notch coating, reverse roll coating, gravure coating, spray coating, bar coating, spin coating and dip coating. Many of these options, when used with higher viscosity first materials, can potentially be used in connection with substrates having three-dimensional structured surfaces that are not contained in cavities.

In one or more embodiments in which the first material is provided in a cavity such as, e.g., cavity 34, the first material may have a lower viscosity because flowing of the first material is not a concern due to the containment provided by, e.g., sidewalls 32 forming cavity 34 above the surface of the substrate 30.

The first material 20 is, in one or more embodiments of the methods described herein, selectively exposed to an incident light having sufficient intensity to cause simultaneous absorption of multiple photons by the first material in the exposed region. The exposure can be accomplished by any method that is capable of providing light with sufficient intensity. Exemplary exposure methods and apparatus are described in U.S. Patent Application Publication US 2009/0099537 (“Process For Making Microneedles, Microneedle Arrays, Masters, And Replication Tools”).

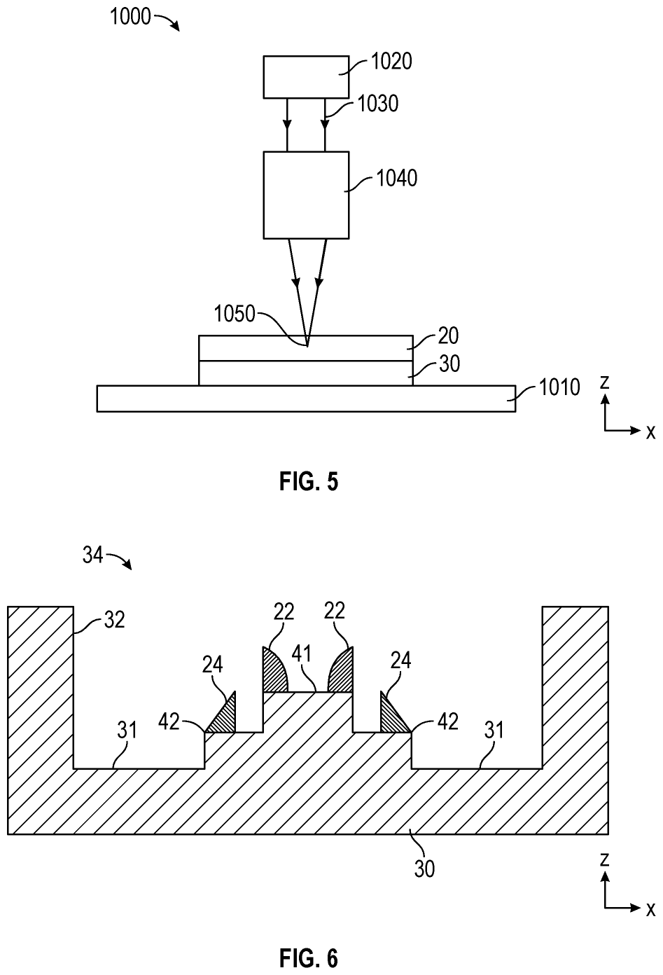

FIG. 5 is a schematic side-view of one exemplary embodiment of an exposure system 1000 for exposing first material 20. The exposure system includes a light source 1020 emitting light 1030 and a stage 1010 that is capable of moving in one, two, or three dimensions. Substrate 30 carrying first material 20 is placed on the stage 1010. Optical system 1040 focuses emitted light 1030 at a focal region 1050 within the first material 20. In one or more embodiments, optical system 1040 is designed so that simultaneous absorption of multiple photons by the first material occurs only at or very near focal region 1050. Regions of first material 20 that undergo the multiphoton reaction become more, or less, soluble in at least one solvent compared to regions of the first material 20 that do not undergo the multiphoton reaction.

Focal region 1050 can scan a three-dimensional pattern within the first material by moving stage 1010 and/or light 1030 and/or one or more components, such as one or more mirrors, in optical system 1040.

Light source 1020 can be any light source that is capable of producing sufficient light intensity to effect multiphoton absorption. Exemplary light sources may include, e.g., lasers, such as femtosecond lasers, operating in a range from about 300 nm to about 1500 nm, or from about 400 nm to about 1100 nm, or from about 600 nm to about 900 nm, or from about 750 to about 850 nm.

Optical system 1040 can include, for example, refractive optical elements (for example, lenses or microlens arrays), reflective optical elements (for example, retroreflectors or focusing mirrors), diffractive optical elements (for example, gratings, phase masks, and holograms), polarizing optical elements (for example, linear polarizers and waveplates), dispersive optical elements (for example, prisms and gratings), diffusers, Pockels cells, waveguides, and the like. Such optical elements are useful for focusing, beam delivery, beam/mode shaping, pulse shaping, and pulse timing.

After selective exposure of the first material 20 by exposure system 1000, the exposed first material is placed in a solvent to dissolve regions of higher solvent solubility. Exemplary solvents that can be used for developing the exposed first material may include, e.g., aqueous solvents such as, for example, water (for example, having a pH in a range of from 1 to 12) and miscible blends of water with organic solvents (for example, methanol, ethanol, propanol, acetone, acetonitrile, dimethylformamide, N-methylpyrrolidone, and the like, and mixtures thereof); and organic solvents. Exemplary useful organic solvents include alcohols (for example, methanol, ethanol, and propanol), ketones (for example, acetone, cyclopentanone, and methyl ethyl ketone), aromatics (for example, toluene), halocarbons (for example, methylene chloride and chloroform), nitriles (for example, acetonitrile), esters (for example, ethyl acetate and propylene glycol methyl ether acetate), ethers (for example, diethyl ether and tetrahydrofuran), amides (for example, N-methylpyrrolidone), and the like, and mixtures thereof.

Referring again to FIG. 4, the first material 20 is, in the methods described herein, provided on a substrate 30 that includes a three-dimensional structured surface. In the depicted exemplary embodiment, the three-dimensional structured surface 40 includes surfaces 41 and 42 that correspond to the first and second inlet surfaces 12 and 13 of the nozzle plate 10. In particular, the three-dimensional structured surface 40 is, in one or more embodiments, used to form the cavity 18 in the nozzle plate 10 as described herein. Although the three-dimensional structured surface used to form the cavity 18 could be formed by the first material 20, doing so would require additional exposure time using, e.g., exposure system 1000 along with additional amounts of first material 20. The additional processing time and materials could increase the cost of the resulting nozzle plates (or other articles).

As used herein, a “three-dimensional structured surface” is a surface that is neither solely flat nor solely spherical in shape with the three-dimensional structured surface being, in or more embodiments, configured to replace at least a portion of a patterned structure that would otherwise be formed using a multi-photon process in the absence of the three-dimensional structured surface. In one or more embodiments, a three-dimensional structured surface as described herein includes two or more ruled surfaces, although ruled surfaces are not required for all three-dimensional structured surfaces used in the methods described herein. In embodiments in which the three-dimensional structured surface includes two or more ruled surfaces, the two or more ruled surfaces may be ruled surfaces that are developed around a common axis.

In one or more embodiments, the three-dimensional structured surface 40 may be located on a surface of the substrate 30 that defines the bottom 31 of, e.g., the cavity 34. While the bottom 31 may be flat or spherical, the three-dimensional structured surface 40 located thereon is, as discussed herein, neither solely flat nor solely spherical. FIG. 6 is a schematic side-view of a microstructured pattern formed in the first material 20 of FIG. 4 using a multiphoton process. As discussed above, the first material 20 that does not form a part of the microstructured pattern has been removed from the cavity 34. The microstructured pattern that remains after removal of the first material 20 includes first microstructured features 22 and second microstructured features 24, both of which are located on the three-dimensional structured surface 40. In particular, the first microstructured features 22 are located on surface 41 of the three-dimensional structured surface 40 and the second microstructured features 24 are located on surface 42 of the three-dimensional structured surface 40. Further, the first microstructured features 22 correspond to the first nozzle through-holes 15 of the nozzle plate 10, while the second microstructured features 24 correspond to the second nozzle through-holes 16 of the nozzle plate 10.

An optional feature depicted in FIG. 4 is that the three-dimensional structured surface may be provided, at least in part, by insert 70 (defined by a broken line extending across the bottom 31 of the cavity 34), with the insert 70 including surfaces 41 and 42 on which microstructured features 22 and 24 are located. The insert 70 may, in one or more embodiments, be in the form of a separate and discrete article located on the support surface 31 of the substrate 30. In contrast, the three-dimensional structured surface of the methods described in connection with FIG. 4 may be integral with the substrate such that it cannot be separated from the substrate without cutting, machining, grinding, etc.

In one or more embodiments, an insert 70 may be constructed of, e.g., materials that are not electrically conductive. For example, the insert 70 may be constructed of a polymeric material with only selected surfaces or portions of the insert 70 being seeded with an electrically conductive material such that electroplating causes the growth of electroplated material onto the conductive surfaces. For example, only upward-facing surfaces 41 and 42 on the insert 70 may be seeded or otherwise made electrically conductive. Alternatively, the insert 70 may be constructed of electrically conductive material with the surfaces other than 41 and 42 being passivated with an insulating layer such that electroplated material does not deposit on the passivated surfaces. In one or more embodiments, the support surface 31 of the substrate 30 may also be electrically conductive such that electroplated material deposits on that surface as well as any of the selected surfaces on the insert 70.

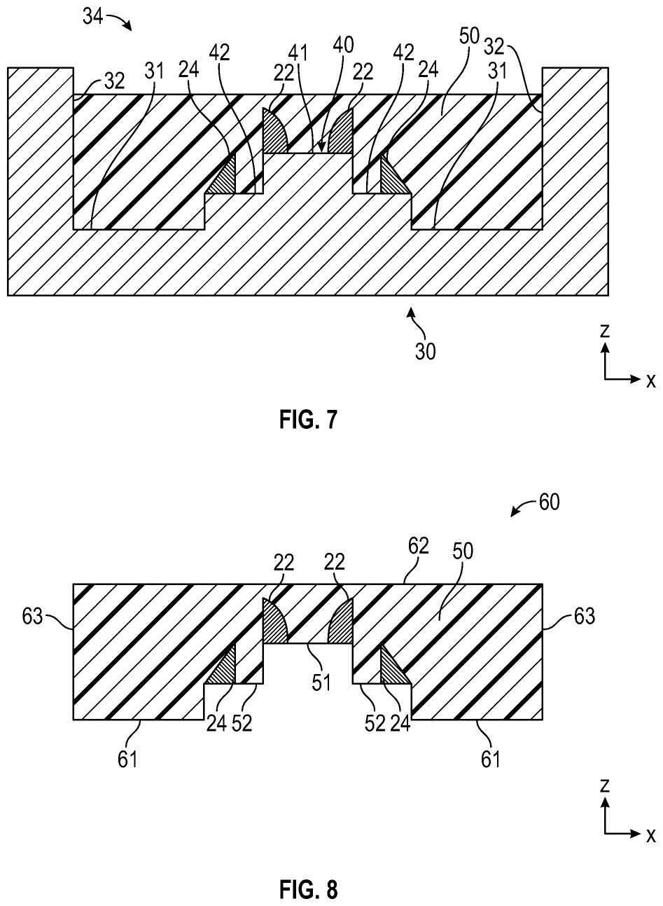

With the microstructured pattern on the three-dimensional structured surface 40 exposed, the microstructured features 22 and 24 of the microstructured pattern and the three-dimensional structured surface 40 may be replicated in a second material 50 that is different from the first material used to form the microstructured pattern (as seen in FIG. 7). In one or more embodiments, replicating the microstructured pattern in the second material may include electroplating the three-dimensional structured surface 40 and, where provided, the bottom 31 of the cavity 34. In one or more embodiments, the second material 50 may contain the microstructured pattern and cover all or at least a portion of the three-dimensional structured surface 40. In one or more embodiments, replicating the microstructured pattern in the second material may include electroplating the microstructured pattern itself.

In those embodiments in which the second material is electroplated, the second material may be in the form of any suitable electroplating material, such as, e.g., elemental or alloyed metals (e.g., Ni, Co, and alloys that include one or both of these metals).

In one or more alternative embodiments, the second material 50 may be any other material suitable for replicating the microstructured pattern and the three-dimensional structured surface 40. One potentially suitable class of materials may include, e.g., ceramics. In one or more embodiments the second material, if in the form of a ceramic, may be selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof.

If electroplating is to be used to replicate the microstructured pattern and the three-dimensional structured surface 40, the bottom 31 of the substrate 30 may preferably be an electrically conductive surface such that the electroplated material forms on the bottom 31 of the substrate 30. Furthermore, in one or more embodiments, the surfaces 41 and 42 of the three-dimensional structured surface 40 are also preferably electrically conductive surfaces such that the electroplating material also forms on the surfaces 41 and 42 of the three-dimensional structured surface 40. In one or more embodiments, the substrate 30 and the three-dimensional structured surface 40 may be constructed of electrically conductive materials and any surfaces on which electroplating is not desired are passivated with one or more non-conductive materials such that the electroplating material deposits only on the electrically conductive surfaces. In one or more alternative embodiments, the substrate 30 and the three-dimensional structured surface are constructed of electrically non-conductive materials and the surfaces on which plating is desired are seeded or otherwise made electrically conductive.

In one or more embodiments, the microstructured features 22 and 24 of the microstructured pattern may also themselves be either made of electrically conductive materials, or may be seeded with a layer of electrically conductive materials to promote the deposition of electroplating material on the features 22 and 24 of the microstructured pattern (potentially useful methods of seeding are described in, e.g., U.S. Pat. No. 9,333,598 B2 and US Patent Application Publication No. US 2013/0313339).

After covering the microstructured pattern and at least a portion of the three-dimensional structured surface 40 in the second material 50, the replicated structure 60 may, in one or more embodiments, be removed from the substrate 30 which, in the case of the depicted embodiment, entails removal of the replicated structure 60 from the cavity 34. When removed from the substrate 30, the microstructured features 22 and 24 of the microstructured pattern may also be removed along with the replicated structure 60. After removal from the substrate 30, the replicated structure 60 provides a negative pattern of the three-dimensional structured surface 40.

The replicated structure 60 includes surface 61 corresponding to the bottom 31 of the substrate 30, surface 62 which is the upper surface of the second material 50 deposited on the substrate 30, first cavity surface 51 corresponding to surface 41 of the three-dimensional structured surface 40, and second cavity surface 52 corresponding to surface 42 of the three-dimensional structured surface 40. In those embodiments in which the second material 50 is deposited into a cavity 34, the replicated structure 60 may include side surfaces 63 corresponding to the side surfaces 32 of the cavity 34.

As seen in, e.g., FIG. 8, the microstructured features 22 and 24 of the microstructured pattern, formed of the first material as described herein, may, in one or more embodiments, also be removed from the three-dimensional structured surface 40 and remain in the second material 50. In one or more embodiments of the methods described herein, the first material forming the features 22 and 24 of the microstructured pattern may also be removed from the second material such that the second material 50 of replicated structure 60 also replicates the microstructured features 22 and 24 of the microstructured pattern as well as the three-dimensional structured surface 40.

In one or more embodiments in which the microstructured pattern is exposed on the upper surface 62 of the replicated structure 60, the first material forming the microstructured pattern (e.g., microstructured features 22 and/or 24), the first material forming the microstructured pattern may be removed before the replicated structure 60 is removed from the substrate 30. In many instances, however, the first material may preferably be contained within the second material of the replicated structure 60 making such removal difficult and/or impossible.

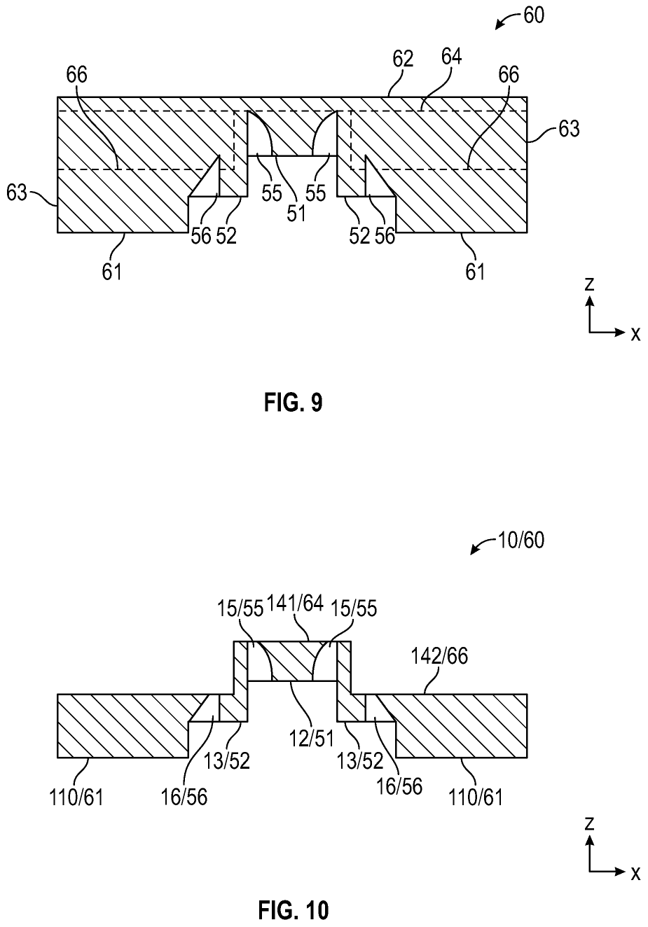

FIG. 9 depicts the replicated structure 60 after having been removed from the substrate 30 and after the microstructured features 22 and 24 of the microstructured pattern has been removed from the replicated structure 60. In one or more embodiments, the replicated structure 60 may form a finished article depending on the purposes for which the article is intended. In one or more embodiments, however, where the replicated structure 60 is to be used as a nozzle structure requiring through-holes, further processing may be required before removing the replicated structure 60 from the substrate 30.

For example, in one or more embodiments, a portion of the second material 50 may be removed from the replicated structure 60. In particular, a portion of the second material 50 from the replicated structure 60 may be removed from the surface 62, i.e., the surface that faces away from the three-dimensional structured surface 40 before the replicated structure 60 is removed from the three-dimensional structured surface 40 in the cavity 34. In one or more embodiments, the second material forming the surface 62 of the replicated structure 60 may be removed to a level indicated by broken line 64 in FIG. 9. Removal of second material from the surface 62 of the replicated structure may include, in one or more embodiments, planarizing that surface of the replicated structure 60 through, e.g., grinding, milling, electron discharge machining (EDM), chemical removal, or other material removal processes.

At the level depicted by broken line 64, cavities 55 formed by the first microstructured features 22 after removal of the first material forming those microstructured features may include an opening at the surface 62 of the replicated structure 60. Referring to, e.g., the nozzle plate 10 depicted in FIGS. 1-3, the openings formed at surface 62 of replicated structures 60 by cavities 55 may correspond to openings 152 in the nozzle plate 10. As a result, cavities 55 may be described as forming features corresponding to through-holes 15 in nozzle plate 10.

Further removal of second material from the replicated structure 60 along broken lines 66 on opposing sides of the portion of the replicated structure 60 containing cavities 55 may, in one or more embodiments, expose openings in cavities 56 provided in replicated structure 60. Referring to, e.g., the nozzle plate 10 depicted in FIGS. 1-3, the openings in cavities 56 formed at the surfaces defined by broken lines 66 may correspond to openings 162 in the nozzle plate 10. As a result, cavities 56 may be described as forming features in the replicated structure that correspond to through-holes 16 in nozzle plate 10. Removal of the second material from replicated structure 60 may be accomplished by any suitable process or processes as described herein.

FIG. 10 is provided to illustrate correspondence between the features found in the nozzle plate 10 and the replicated structure 60. In particular, through-holes 15 in nozzle plate 10 correspond to cavities 55 in the replicated structure 60. Through-holes 16 in nozzle plate 10 correspond to cavities 56 in the replicated structure 60. Surface 12 in the nozzle plate 10 corresponds to surface 51 in the replicated structure 60. Surface 13 in the nozzle plate 10 corresponds to surface 52 in the replicated structure 60. Surface 110 in the nozzle plate 10 corresponds to surface 61 in the replicated structure 60. Surface 141 in the nozzle plate 10 corresponds to surface 64 formed by removal of a first portion of the second material along broken line 64 in, e.g., FIG. 9. Surface 142 in nozzle plate 10 corresponds to surface 66 formed by removal of a second portion of the second material along broken lines 66 in, e.g., FIG. 9. In those embodiments in which the second material is suitable for use as a nozzle structure (e.g., one or more metals, ceramics, etc.), completion of the replicated structure 60 corresponds with completion of a nozzle structure that may be used in connection with a fuel injector nozzle as described herein (although some additional processing may be desirable and/or necessary such as, e.g., deburring (e.g., mechanical and/or chemical), polishing, etc.

In one or more alternative embodiments, however, the replicated structure 60 (as depicted in, e.g., FIG. 9) may be used to construct a second generation mold that can then be replicated to form nozzle structures. Examples of some potentially suitable methods of forming such molds are described in, e.g., U.S. Pat. No. 9,333,598 B2 and US Patent Application Publication No. US 2013/0313339.

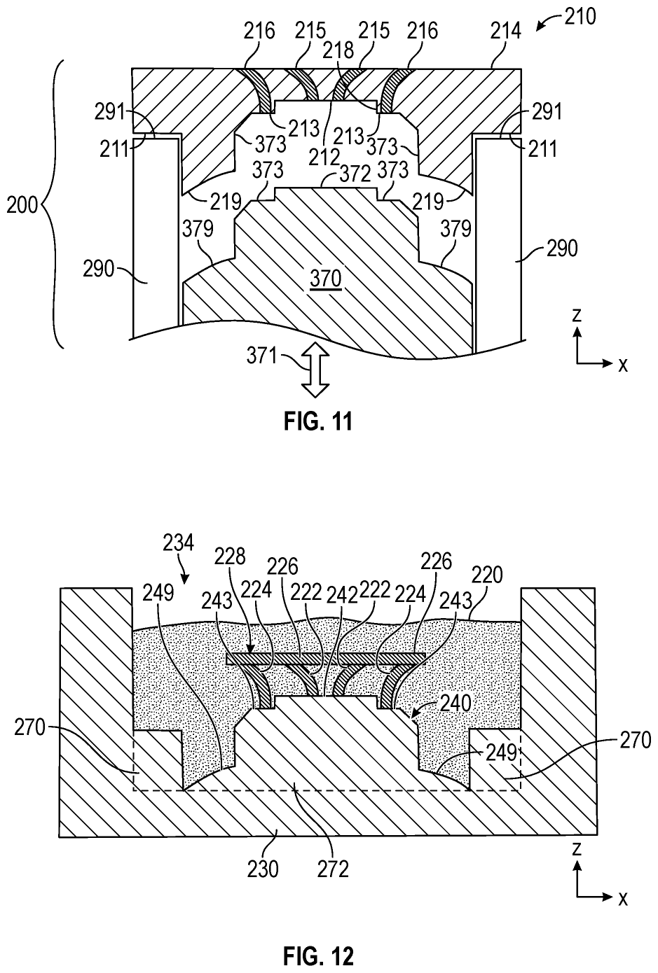

One illustrative embodiment of a fuel injector valve 200 including another exemplary embodiment of a nozzle structure in the form of a nozzle plate 210 and a valve 370 located in an injector body 290 is depicted in FIG. 11. The nozzle plate 210, which may be manufactured using the methods described herein, includes an outlet face 214 and an inlet face 211, where the inlet face 211 faces the valve 370. The nozzle plate 210 is attached, in one or more embodiments, to the valve body 290 where the inlet face 211 abuts the periphery 291 of the valve body 290. The attachment of the nozzle plate 210 to the valve body 290 may be accomplished using any one or more suitable techniques such as, e.g., welding, etc.

The nozzle plate 210 includes a first set of through-holes 215 and a second set of through-holes 216. The through-holes 215 include openings in a surface 212 on the inlet face 211 facing the valve 370, with the surface 212 facing surface 372 on the valve 370. The through-holes 216 include openings in surface 213 that also faces surface 373 on the valve 370. Other features seen on the inlet face 211 of the nozzle plate 210 include valve sealing surfaces 219 which face and are, in the depicted embodiment, shaped to match the sealing surfaces 379 on the valve 370. Contact between the valve sealing surfaces 219 on the nozzle plate 210 and sealing surfaces 379 on the valve 370 may, in one or more embodiments, prevent the flow of fuel through the fuel injector 200 when surfaces 219 and 319 contact each other.

The fuel injector 200 provides one example of a potential advantage of manufacturing nozzle structures for fuel injectors using a three-dimensional structured surface as described herein. As discussed, the inlet face of nozzle structures manufactured using one or more embodiments of the methods described herein may take a shape that is complementary to the shape of a valve used in connection with the nozzle structure such that the SAC volume in a fuel injector can be reduced.

In the embodiment of fuel injector 200, it can be seen that the shape of the valve 370 closely matches the shape of the inlet face 211 of the nozzle plate 210. Such a combination can significantly reduce the SAC volume, i.e., the volume of space between the inlet face 211 of the fuel injector nozzle plate 210 and the valve 370 of the fuel injector system when the valve 370 is in a closed position relative to the nozzle plate 210.

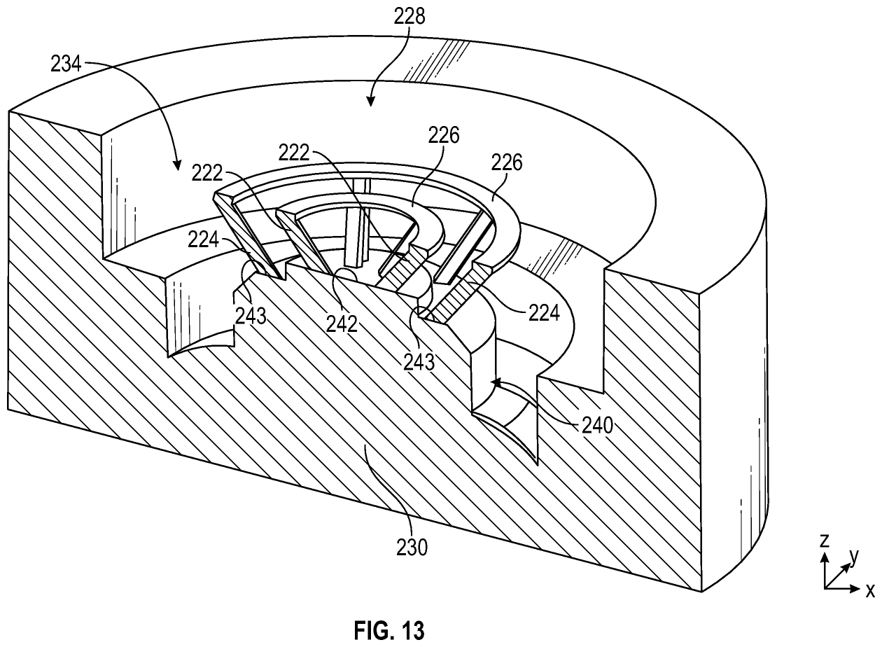

To achieve that reduction in SAC volume in a nozzle structure manufactured according to one or more embodiments of the methods described herein, the three-dimensional structured surface on which the nozzle structure is manufactured can be shaped to match the shape of the valve with which the nozzle structure will be used. Referring to, e.g., FIG. 12, the substrate 230 includes a three-dimensional structured surface 240 that is shaped to match the shape of the valve 370 as depicted in, e.g., FIG. 11. In particular, the three-dimensional structured surface 240 includes a surface 242 that corresponds to surface 372 on valve 370, as well as surfaces 243 that match surfaces 373 on the valve 370. Furthermore, the three-dimensional structured surface 240 also includes surfaces 249 that correspond to sealing surfaces 379 on the valve 370.

Although not required, the three-dimensional structured surface 240 on substrate 230 may be located in a cavity 234 similar to the cavity 34 described in connection with, e.g., FIG. 4. As in that embodiment, the three-dimensional structured surface 240 may be described as being contained within the cavity 234.

An optional feature depicted in FIG. 12 is that the three-dimensional structured surface 240 in the cavity 234 may be provided, at least in part, by one or more inserts. In the depicted illustrative embodiment, two inserts 270 and 272 (both defined by broken lines in FIG. 12) are provided, with a first insert 270 being in the form of a ring and a second insert 272 including the surfaces 242, 243, and 249 of the three-dimensional structured surface 240 located in the cavity 234. The inserts 270 and/or 272 may, in one or more embodiments, be in the form of separate and discrete articles located in the cavity 234 provided in the substrate 230. As depicted in solid lines in FIG. 12, the three-dimensional structured surface 240 may be integral with the substrate such that it cannot be separated from the substrate without cutting, machining, grinding, etc.

In one or more embodiments, one or both of the inserts 270 and 272 may be constructed of, e.g., materials that are not electrically conductive. For example, one or both of the inserts 270 and 272 may be constructed of a polymeric material with only selected surfaces or portions of the inserts being seeded with an electrically conductive material such that electroplating causes the growth of electroplated material onto the conductive surfaces. For example, only upward-facing surfaces 242, 243, and 249 may be seeded or otherwise made electrically conductive. Alternatively, one or both of the inserts 270 and 272 may be constructed of electrically conductive material with the surfaces other than surfaces 242, 243, and 249 being passivated with an insulating layer such that electroplated material does not deposit on the passivated surfaces.

The first material 220 provided in the cavity 234 may, in one or more embodiments, be capable of undergoing multiphoton reaction by simultaneously absorbing multiple photons as described herein. For example, in one or more embodiments, the first material is capable of undergoing a two photon reaction by simultaneously absorbing two photons. The first material can be any material or material system that is capable of undergoing multiphoton, such as two photon, reaction, such as those described in U.S. Pat. No. 7,583,444 (“Process For Making Microlens Arrays And Masterforms”); U.S. Patent Application Publication US 2009/0175050 (“Process For Making Light Guides With Extraction Structures And Light Guides Produced Thereby”); and PCT Publication WO 2009/048705 (“Highly Functional Multiphoton Curable Reactive Species”).

The first material 220 is, in one or more embodiments of the methods described herein, selectively exposed to an incident light having sufficient intensity to cause simultaneous absorption of multiple photons by the first material in the exposed region.

The exposure can be accomplished by any method that is capable of providing light with sufficient intensity. Exemplary exposure methods are described in U.S. Patent Application Publication US 2009/0099537 (“Process For Making Microneedles, Microneedle Arrays, Masters, And Replication Tools”) and one exemplary embodiment of a system capable of providing such light is depicted in FIG. 5 above.

FIG. 12 depicts one illustrative embodiment of a microstructured pattern 228 (in broken lines) to be formed in the first material 220, while FIG. 13 is a cross-sectional perspective view of the microstructured pattern 228 formed on the three-dimensional structured surface 240 in the first material 220 of FIG. 12 using, e.g., a multiphoton process. The first material 220 that does not form a part of the microstructured pattern 228 has been removed from the cavity 234 in the view seen in FIG. 13.

Referring to both FIGS. 12 and 13, the microstructured pattern 228 formed in the first material 220 in the cavity 234 in FIG. 12 and that remains in that cavity after removal of the first material 220 from the cavity 234 in FIG. 13 includes first microstructured features 222 and second microstructured features 224, both of which are located on and extend away from the three-dimensional structured surface 240. In particular, the first microstructured features 222 are located on surface 242 of the three-dimensional structured surface 240 and the second microstructured features 224 are located on surface 243 of the three-dimensional structured surface 240.

The first microstructured features 222 correspond, generally, to the first nozzle through-holes 215 of the nozzle plate 210, while the second microstructured features 224 correspond to the second nozzle through-holes 216 of the nozzle plate 210. In addition to the first and second microstructured features 222 and 224, the microstructured pattern 228 includes one or more support features 226 that connect to one or more of the microstructured features 222 and/or 224. In particular, the support feature 226 depicted in FIGS. 12 and 13 is attached to the distal ends of each of the microstructured features 222 and 224. In one or more embodiments, the support feature 226 may be described as being spaced apart from the three-dimensional structured surface 240, meaning that the support feature 226 is not located on the three-dimensional structured surface itself.

The distal ends of the microstructured features 222 and 224 are distal from the surfaces of the three-dimensional structured surface 240 from which they extend. For example, in one or more embodiments, the microstructured features 222 and 224 may be described as having a base on the three-dimensional structured surface 240 and a distal end located distal from the base. In one or more embodiments, the support feature 226 may be used to provide additional structural integrity to microstructured features 222 and/or 224 by, e.g., connecting the distal ends of the microstructured features 222 and 224 to each other (noting that, in one or more embodiments, not all of the microstructured features need necessarily be connected to a support feature).

With the microstructured pattern 228 on the three-dimensional structured surface 240 exposed as seen in FIG. 13, the microstructured pattern 228 and the three-dimensional structured surface 240 may be replicated in a second material 250 that is different from the first material used to form the microstructured pattern 228. In one or more embodiments, replicating the microstructured pattern 228 in the second material 250 may include, as described herein, electroplating the three-dimensional structured surface 240 and, where provided, the cavity 234. In the depicted embodiment, the bottom of the cavity 234 includes surfaces 237 and 239 (wherein surfaces 239 correspond to valve sealing surfaces 219 on the nozzle plate 210). In one or more embodiments, the second material 250 may contain the microstructured pattern 228 and cover all or a portion of the three-dimensional structured surface 240.

If electroplating is to be used to replicate the microstructured pattern 228 and the three-dimensional structured surface 240, the bottom of the cavity 234 in the substrate 230 may preferably be an electrically conductive surface. Furthermore, in one or more embodiments, the upward facing surfaces 242, 243, and 249 of the three-dimensional structured surface 240 are also preferably electrically conductive surfaces such that the electroplating material also preferentially forms on the upward facing surfaces 242, 243, and 249 of the three-dimensional structured surface 240.

In one or more embodiments, the microstructured features of the microstructured pattern 228 may also themselves be either made of electrically conductive materials, or may be seeded with electrically conductive materials to promote the deposition of electroplating material on the microstructured pattern 228.

After containing of the microstructured pattern 228 and covering at least a portion the three-dimensional structured surface 240 in the second material 250, the mass of second material 250 may be removed from the cavity 234 as depicted in FIG. 15. When removed from the substrate 230, the microstructured features of the microstructured pattern 228 may also be removed along with the second material 250. After removal from the cavity 234, the second material 250 forming the replicated structure 260 replicates the three-dimensional structured surface 240 and also includes cavities corresponding to the microstructured pattern 228. In embodiments in which the microstructured pattern is contained within in the second material 250, the first material of the microstructured pattern 228 is still located in those cavities until removed.

The replicated structure 260, if made of metal or other materials suitable for use as a nozzle plate 210, may, in one or more embodiments, include surfaces corresponding to the surfaces found on the inlet face 211 of the nozzle plate 210 depicted in FIG. 11. In particular, the replicated structure 260 includes surfaces 212 and 213 of nozzle plate 210, along with valve sealing surfaces 219 of nozzle plate 210.

On the outlet face 214, the replicated structure 260 may, in one or more embodiments, need additional processing to provide a suitable nozzle plate 210 if the second material 250 is suitable for use as a nozzle plate 210. For example, in one or more embodiments, a portion of the second material 250 forming the outlet face 214 of the replicated structure 260 may be removed to, e.g., the level of the broken line 264 in FIG. 15. Removal of the second material 250 to that level may also preferably remove the support feature 226 of the microstructured pattern 228. Removal of the first material in the remaining microstructured features 222 and 224 of the microstructured pattern 228 will then result in through-holes 215 and 216 of the nozzle plate 210. In those embodiments in which the second material is suitable for use as a nozzle structure (e.g., one or more metals, ceramics, etc.), removal of the first material corresponds with completion of a nozzle plate 210 that may be used in connection with a fuel injector nozzle as described herein (although some additional processing may be desirable and/or necessary such as, e.g., deburring (e.g., mechanical and/or chemical), polishing, etc.

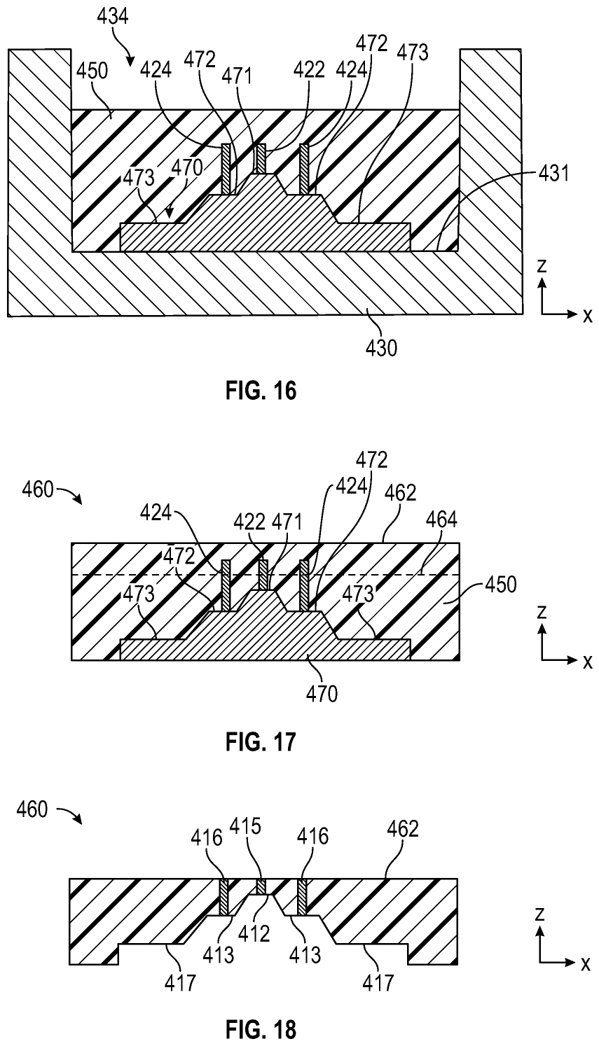

Another illustrative embodiment of a method of manufacturing a nozzle structure as described herein may be described with reference to FIGS. 16-18. In particular, FIG. 16 depicts the process after formation of a microstructured pattern in a first material in the form of microstructured features 422 and 424 as discussed herein in connection with other embodiments. The microstructured features 422 and 424 are located on and extend away from a three-dimensional structured surface provided by an insert 470 that is located on a support surface 431 of substrate 430. The insert 470 and support surface 431 are, in the depicted embodiment, located in a cavity 434. Also depicted in FIG. 16 is a layer of second material 450 that replicates both the microstructured pattern formed by microstructured features 422 and 424 and the three-dimensional structured surface provided by the insert 470.

Similar to the other exemplary embodiments described herein, the method depicted in FIGS. 16-18 includes a three-dimensional structured surface on which the microstructured pattern is formed. In this exemplary embodiment, the three-dimensional structured surface is provided, at least in part, by insert 470 which includes a surface 471 on which microstructured feature 422 is located and a surface 472 on which microstructured features 424 are located. The insert 470 also includes a surface 473 surrounding surface 472. The insert 470 is a separate and discrete article located on the support surface 431 of the substrate 430. In contrast, the three-dimensional structured surface of the methods described in connection with FIGS. 4 and 12 are integral with the substrate such that they cannot be separated from the substrate without cutting, machining, grinding, etc.

In one or more embodiments, the insert 470 may be constructed of, e.g., materials that are not electrically conductive. For example, the insert 470 may be constructed of a polymeric material with only selected surfaces or portions of the insert 470 being seeded with an electrically conductive material such that electroplating causes the growth of electroplated material onto the conductive surfaces. For example, only upward-facing surfaces 471, 472, and 473 on the insert 470 may be seeded or otherwise made electrically conductive. Alternatively, the insert 470 may be constructed of electrically conductive material with the surfaces other than 471, 472, and 473 being passivated with an insulating layer such that electroplated material does not deposit on the passivated surfaces. In one or more embodiments, the support surface 431 of the substrate 430 may also be electrically conductive such that electroplated material deposits on that surface as well as any of the selected surfaces on the insert 470.

With reference to FIG. 17, that second material 450 and the insert 470 are depicted removed from the cavity 434 to provide a replicated structure 460 in which both the microstructured pattern and the three-dimensional structured surface of the insert 470 are replicated. In the depicted method, insert 470 remains attached to the replicated structure 460 in this part of the process, but, in one or more embodiments, the insert 470 may be separated from the replicated structure 460 during the process of removing the replicated structure 460 from the cavity 434.

As discussed above in connection with other embodiments of the methods described herein, a portion of the upper surface 462 of the replicated structure 460 may be removed to expose portions of the microstructured features 422 and 424 of the microstructured pattern. Broken line 464 in FIG. 17 depicts one exemplary level to which the second material forming the upper surface 462 may be removed. Removal of the second material 450 may be accomplished through any suitable technique or combination of techniques such as, e.g., grinding, milling, machining, EMD, etc.

Removal of both the insert 470 and the first material in the microstructured features 422 and 424, along with removal of a portion of the second material 450 to the level of the broken line 464 result in the replicated structure 460 as depicted in FIG. 18. In particular, removal of the first material in the microstructured features 422 and 424 results in through-holes 415 and 416, with all of the through-holes 415 and 416 having openings on the surface 462 which may correspond to the outlet surface of a nozzle structure such as, e.g., a nozzle plate. Further, through-hole 415 has an opening in surface 412 on the inlet face of the nozzle structure, while through-holes 416 have openings in the surface 413 of the nozzle structure formed by replicated structure 460. In those embodiments in which the second material is a material (e.g., one or more metals, ceramics, etc.) suitable for use as a nozzle structure, removal of the first material corresponds with completion of a replicated structure 460 that may be used as a nozzle structure in connection with a fuel injector nozzle as described herein (although some additional processing may be desirable and/or necessary such as, e.g., deburring (e.g., mechanical and/or chemical), polishing, etc.

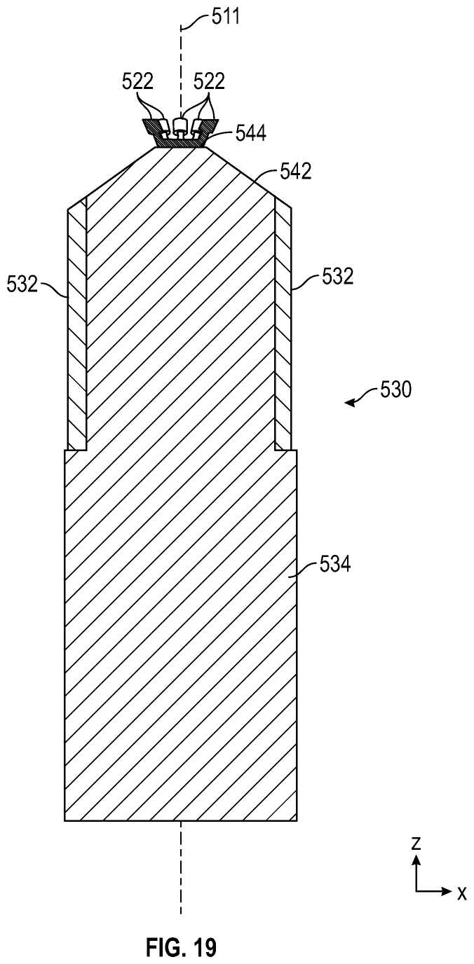

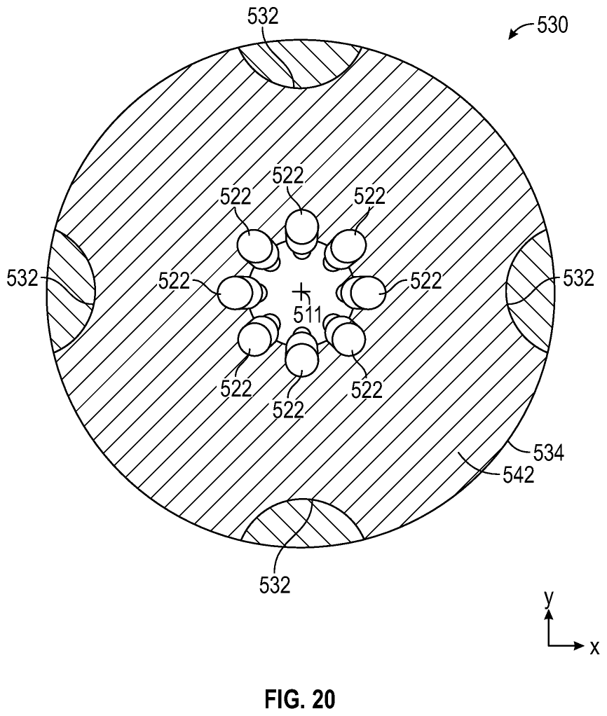

Another illustrative embodiment of a method of making a nozzle structure (e.g., a nozzle plate, valve guide, combined nozzle plate and valve guide, etc.) can be described in connection with FIGS. 19-24. In the depicted method, the three-dimensional structured surface on which the nozzle structure is formed can be the actual valve to be used with the nozzle structure to control the flow of fuel through a fuel injector. Alternatively, the three-dimensional structured surface may not be the valve itself, but may be in the shape of, or at least include, the structural features of a valve (e.g., a ball valve, etc.) that will be used in connection with the nozzle structure to form a fuel injector nozzle. As discussed herein in connection with the illustrative embodiment of nozzle plate 210 manufactured according to the method described in connection with FIGS. 11-15, the inlet face of nozzle structures manufactured using a method in which the three-dimensional structured surface includes a shape similar to that found in the valve of a fuel injector may be useful in reducing SAC volume of a fuel injector.

Referring to, e.g., FIGS. 19-20, one illustrative embodiment of a pin 530 include a three-dimensional structured surface on its distal end can be used to form a nozzle structure. The pin 530 includes features designed to complement features found in a valve with which the resulting nozzle structure may be used.

For example, the pin 530 may include surface 531 from which surface 542 extends. Surface 542 may, for example, provide a valve sealing surface on a nozzle structure formed on the pin 530 that may complement a sealing surface found on a valve used in connection with a nozzle structure manufactured using pin 530. Another illustrative example of complementary sealing surfaces are found in sealing surface 379 of valve 370 and sealing surfaces 219 on nozzle plate 210 as depicted in, e.g., FIG. 11.

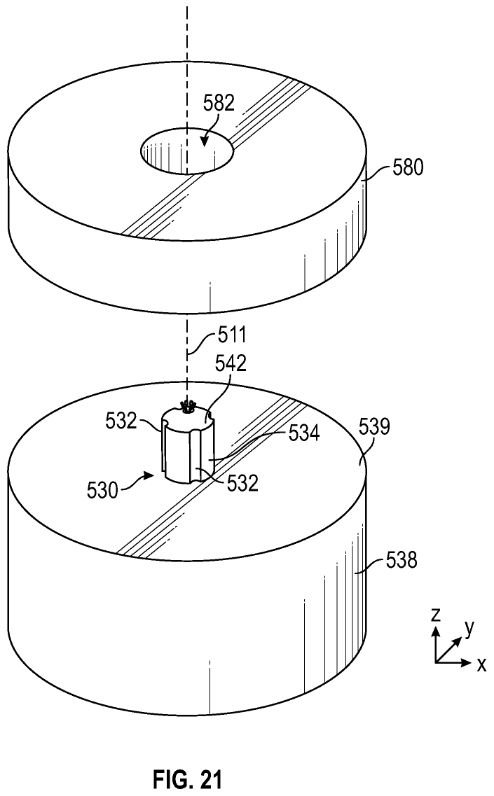

In addition to sealing surface formed using surface 542, surface 544 found at the uppermost end of surface 542 may provide a surface on which microstructured features may be formed that will result in through-holes as described in connection with nozzle structures as described herein. One exemplary embodiment of a microstructured pattern including microstructured features 522 formed on the surface 544 is depicted in FIGS. 20-21. The microstructured features 522 of the microstructured pattern may, in one or more embodiments, be used to provide through-holes in a nozzle structure formed using pin 530. Furthermore, the microstructured features 522 of the microstructured pattern may be formed using a material capable of undergoing multiphoton reaction by simultaneously absorbing multiple photons as described herein. For example, in one or more embodiments, the first material is capable of undergoing a two photon reaction by simultaneously absorbing two photons. The first material can be any material or material system that is capable of undergoing multiphoton, such as two photon, reaction, such as those described in U.S. Pat. No. 7,583,444 (“Process For Making Microlens Arrays And Masterforms”); U.S. Patent Application Publication US 2009/0175050 (“Process For Making Light Guides With Extraction Structures And Light Guides Produced Thereby”); and PCT Publication WO 2009/048705 (“Highly Functional Multiphoton Curable Reactive Species”).

Another feature found on illustrative embodiment of pin 530 that may be used to form features of a nozzle structure that is complementary with a valve is found in alignment guides 532 that extend along the side 534 of the pin 530. The alignment guides 532 are aligned with a longitudinal axis 511 that extends through pin 530 and, in particular, through surface 544 containing the microstructured pattern of microstructured features 522. In one or more embodiments, a valve used with a nozzle structure manufactured using pin 530 may reciprocate along axis 511 when opening and closing during use.

In the depicted illustrative embodiment, four alignment guides are depicted, although any number of alignment guides 532 could be provided on pin 530. Further, the form of the alignment guides 532 provided on a pin 530 may also vary depending on the form of the complementary guides on a valve with which a nozzle structure formed using pin 530 may be used. For example, alignment guides 532 are provided in the form of slots or channels in the depicted illustrative embodiment. Other embodiments of alignment guides may include, for example, ridges, splines, etc.

FIG. 21 is an exploded diagram of one illustrative embodiment of an electroforming fixture in which a pin, such as pin 530, may be used to form a nozzle structure according to the methods described herein. The pin 530 may, in one or more embodiments, preferably be constructed such that the exterior surfaces of the pin 530 are electrically conductive. In one or more embodiments, the pin 530 may be constructed completely of an electrically conductive material such as, e.g., an electrically conductive metal or metal alloy.

The pin 530 may be positioned in an opening formed in a base 538 such that the pin 530 is held in an upright orientation as seen in, e.g., FIG. 21. In one or more embodiments, the base 538 may include an electrically conductive surface 539 in contact with the electrically conductive surfaces of pin 530 such that the electrically conductive surfaces of pin 530 may be held at the same electric potential as base surface 539 during an electroforming process.

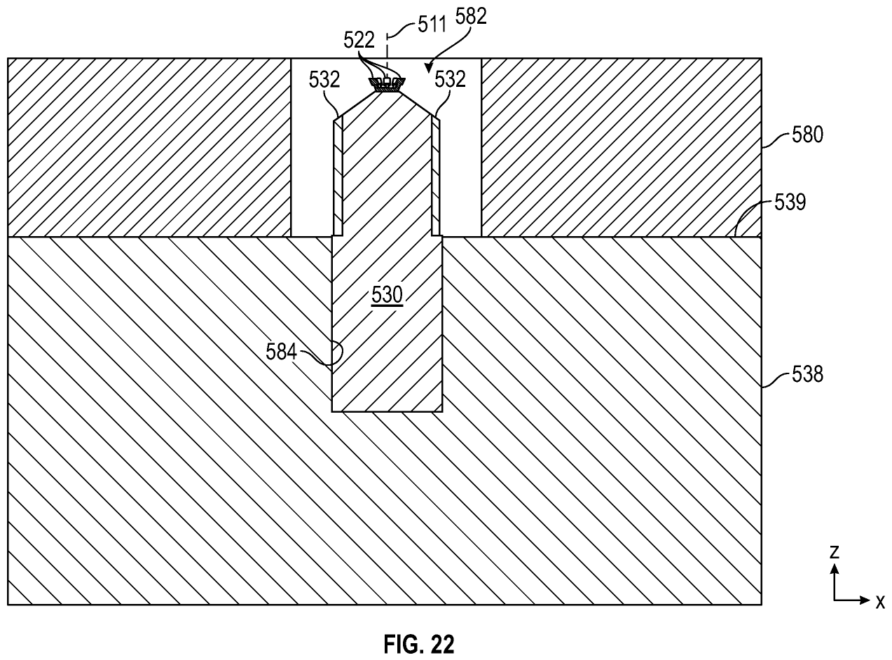

The fixture depicted in FIG. 21 also includes an electrically nonconductive cover plate 580 including a cavity 582 into which pin 530 is located when the cover plate 580 is positioned on the base 538. Although described as being electrically nonconductive, the cover plate 580 may include only nonconductive surfaces surrounding the pin 530. In particular, the pin 530 may be located in a cavity 582 as depicted in FIG. 22, with only the surfaces surrounding the pin 530 being electrically nonconductive. Typically, however, the entire cover plate 580 may be constructed of a non-electrically conductive material. Pin 530 is located within cavity 582, in one or more embodiments, by inserting pin 530 through opening 584 in cover plate 580. In one or more embodiments, the pin 530 may form a seal with opening 584 in cover plate 580 such that an electroforming bath may be contained within cavity 582 during electroforming of a nozzle structure using pin 530 as described herein.

Although the fixture assembly depicted in FIG. 21 includes only one cavity 582 in cover plate 580 and only one pin 530 in base 538, one or more alternative embodiments of fixture assemblies that may be used to manufacture nozzle structures as described herein may include a base capable of receiving two or more pins along with a corresponding cover plate 580 including two or more cavities sized and spaced to receive the pins to allow for simultaneous electroforming of two or more nozzle structures.

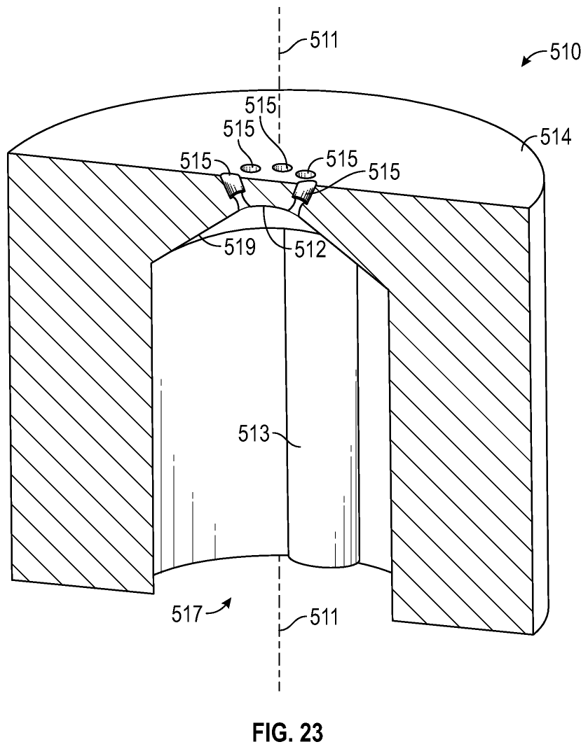

When placed in an electroforming bath which fills the cavity 582, the resulting nozzle structure 510 as depicted in the cross-sectional perspective view of FIG. 23 can be formed. Nozzle structure 510 includes a surface 512 which corresponds to surface 544 on pin 530 along with through holes 515 which are formed after removal of the first material forming the microstructured features 522 of the microstructured pattern formed on surface 544. Each of the through holes 515 opens onto the outlet surface 514 of nozzle structure 510. Valve sealing surface 519 of nozzle structure 510 is formed by surface 542 on pin 530. In essence, cavity 517 in nozzle structure 510 takes the shape of the pin 530 which functions as a three-dimensional structured surface as described herein.

Further, one alignment feature 513 (aligned with axis 511) formed by one of the alignment guides 532 on pin 530 is depicted within the interior cavity of a nozzle structure 510. The depiction of only one alignment feature 513 in the view of FIG. 23 illustrates the concept that the nozzle structure 510 may include fewer than four alignment features 513 (e.g., the nozzle structure 510 may include only three alignment features with only one such feature visible in FIG. 23). Alternatively, one or more embodiments of nozzle structures that include alignment features may include more than four alignment features.

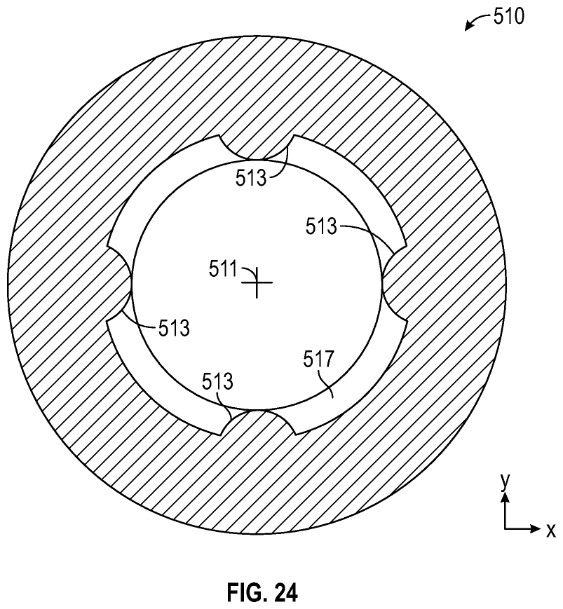

FIG. 24 depicts a partial cross-sectional view taken along axis 511 with a valve 670 located within cavity 517 of nozzle structure 510. As seen in this figure, the valve 670 is located within the alignment features 513 on nozzle structure 510 such that those alignment features serve as valve guides that assist in maintaining proper alignment of the valve 670 within the cavity 517 of nozzle structure 510 as it moves along axis 511 during use of the nozzle structure 510 in a fuel injector as described herein.

Removal of the nozzle structure 510 from pin 530 may be followed by some additional processing as may be desirable and/or necessary to form a completed nozzle structure suitable for use in a fuel injector nozzle as described herein, such as, e.g., deburring (e.g., mechanical and/or chemical), polishing, etc.

### RELATED APPLICATIONS

The methods of manufacturing nozzle structures as discussed herein may be, in one or more embodiments, used in combination with the methods of manufacturing nozzle structures as discussed in and/or the nozzle structures described in the following co-pending applications: METHOD OF ELECTROFORMING MICROSTRUCTURED ARTICLES, U.S. Provisional Application No. 62/438,567, filed on Dec. 23, 2016 (Attorney Docket No. 78371US002) and NOZZLE STRUCTURES WITH THIN WELDING RINGS AND FUEL INJECTORS USING THE SAME, U.S. Provisional Application No. 62/438,558, filed on Dec. 23, 2016 (Attorney Docket No. 77311US002).

### ILLUSTRATIVE EMBODIMENTS

1. A method of fabricating a nozzle structure, the method comprising:

forming a microstructured pattern on at least a portion, most or all of a three-dimensional structured surface by multi-photon processing a first material;

replicating a negative of the microstructured pattern and at least a portion, most or all of the three dimensional structured surface using a second material, different than the first material, to form a replicated structure having a negative pattern of the microstructured pattern and a negative surface of at least a portion of the three dimensional structured surface (i.e., a negative pattern/surface); and

separating the replicated structure from the microstructured pattern and three-dimensional structured surface (e.g., by removing the replicated structure from the three-dimensional structured surface and removing the microstructured pattern from the replicated structure).

2. The method of embodiment 1, wherein the method further comprises removing a portion of the second material from the replicated structure, after said replicating and either before or after said separating.
3. The method of embodiment 2, wherein said removing second material occurs after the replicated structure is separated from the three-dimensional structured surface.
4. The method of embodiment 2 or 3, wherein said removing second material from the replicated structure comprises removing second material from a surface of the replicated structure that faces away from the three-dimensional structured surface, before said separating.
5. The method of any one of embodiments 2 to 4, wherein removing a portion of the second material from the replicated structure comprises planarizing a surface of the replicated structure.
6. The method of any one of embodiments 2 to 4, wherein removing a portion of the second material from the replicated structure comprises machining a surface of the replicated structure.
7. The method of any one of embodiments 1 to 6, wherein the three-dimensional structured surface is located on a bottom of a cavity, and the first material is located in the cavity before multi-photon processing the first material.
8. The method of embodiment 7, wherein the cavity contains a discrete volume of the first material above the three-dimensional structured surface.
9. The method of any one of embodiments 1 to 8, wherein the three-dimensional structured surface comprises two discrete ruled surfaces.
10. The method of any one of embodiments 1 to 8, wherein the three-dimensional structured surface comprises two discrete ruled surfaces and wherein at least a portion of the microstructured pattern is formed on the two discrete ruled surfaces.
11. The method of any one of embodiments 1 to 10, wherein the three-dimensional structured surface is electrically conductive.
12. The method of any one of embodiments 1 to 10, wherein the three-dimensional structured surface is not electrically conductive.
13. The method of any one of embodiments 1 to 12, wherein the three-dimensional structured surface comprises an insert provided as a separate and discrete article located on a support surface of the substrate.
14. The method of embodiment 13, wherein the support surface does not form a portion of the three-dimensional structured surface.
15. The method of embodiment 13, wherein the three-dimensional structured surface comprises surfaces of both the support surface and the insert.
16. The method of any one of embodiments 13 to 15, wherein the insert is submerged in the first material before said forming a microstructured pattern.
17. The method of any one of embodiments 13 to 16, wherein said separating the replicated structure from the three-dimensional structured surface comprises removing the insert.
18. The method of any one of embodiments 1 to 12, wherein the three-dimensional structured surface is a one-piece, completely integral article with the substrate, e.g., the three-dimensional structured surface comprises a portion, most or all of a fuel injector valve.
19. The method of any one of embodiments 1 to 18 wherein the microstructured pattern comprises a plurality of microstructured features, and each microstructured feature is formed on the three-dimensional structured surface.
20. The method of embodiment 19, wherein each microstructured feature of the plurality of microstructured features comprises a base formed on the three-dimensional structured surface and a distal end distal from the three-dimensional structured surface.
21. The method of any one of embodiments 19 to 20, wherein the microstructured pattern comprises at least one support feature attached to the distal end of two or more or all of the plurality of microstructured features.
22. The method of embodiment 21, wherein the support feature is spaced apart from the three-dimensional structured surface.
23. The method of any one of embodiments 21 to 22, further comprising removing second material from the replicated structure, after said replicating, and said removing second material from the replicated structure comprises removing a portion, most or all of the support feature.
24. The method of embodiment 23, wherein said removing second material from the replicated structure occurs after the replicated structure is separated from the three-dimensional structured surface.
25. The method of any one of embodiments 23 to 24, wherein said removing second material from the replicated structure comprises removing second material from a surface of the replicated structure that faces away from the three-dimensional structured surface, before the replicated structure is separated from the three-dimensional structured surface.
26. The method of any one of embodiments 23 to 25, wherein said removing second material from the replicated structure comprises planarizing a surface of the replicated structure.
27. The method of any one of embodiments 23 to 25, wherein said removing second material from the replicated structure comprises machining a surface of the replicated structure.
28. The method of any one of embodiments 19 to 27, wherein each microstructured feature of the plurality of microstructured features is a three-dimensional curvilinear body.
29. The method of any one of embodiments 19 to 27, wherein each microstructured feature of the plurality of microstructured features comprises a portion of a cone.
30. The method of any one of embodiments 19 to 27, wherein each microstructured feature of the plurality of microstructured features comprises a tapered microstructured feature.
31. The method of any one of embodiments 19 to 27, wherein each microstructured feature of the plurality of microstructured features comprises a spiraling microstructured feature.
32. The method of any one of embodiments 1 to 31, wherein the first material comprises poly(methyl methacrylate).
33. The method of any one of embodiments 1 to 31, wherein forming the microstructured pattern comprises a two photon reaction in the first material.
34. The method of any one of embodiments 1 to 31, wherein forming the microstructured pattern comprises delivering energy to the first material using a two photon process.
35. The method of any one of embodiments 1 to 31, wherein forming the microstructured pattern in the first material comprises exposing at least a portion of the first material to cause a simultaneous absorption of multiple photons.
36. The method of any one of embodiments 1 to 35, wherein said replicating comprises electroplating the three-dimensional structured surface.
37. The method of any one of embodiments 1 to 35, wherein said replicating comprises electroplating the three-dimensional structured surface such that the microstructured pattern is contained within the second material.
38. The method of any one of embodiments 1 to 35, wherein said replicating comprises electroplating the microstructured pattern.
39. The method of any one of embodiments 1 to 35, wherein said replicating comprises electroplating the microstructured pattern such that the microstructured pattern is contained within the second material.
40. The method of any one of embodiments 1 to 35, wherein the second material comprises electroplating material.
41. The method of any one of embodiments 1 to 35, wherein the second material comprises a metal.
42. The method of any one of embodiments 1 to 35, wherein the second material comprises Ni.
43. The method of any one of embodiments 1 to 35, wherein the second material comprises a ceramic.
44. The method of embodiment 43, wherein the ceramic is selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof.
45. The method of any one of embodiments 1 to 44, wherein after said separating, the microstructured pattern defines a plurality of through-holes extending through the replicated structure from an inlet face of the replicated structure to an outlet face of the replicated structure.
46. The method of embodiment 45, wherein the method further comprises removing second material from the negative surface of the replicated structure .
47. The method of embodiment 46, wherein said removing second material from the negative surface of the replicated structure occurs after said separating the replicated structure from the three-dimensional structured surface.
48. The method of any one of embodiments 46 to 47, wherein said removing second material from the replicated structure comprises removing second material from the outlet face of the replicated structure.
49. The method of any one of embodiments 46 to 48, wherein said removing second material from the replicated structure comprises planarizing at least a portion of the outlet face of the replicated structure.
50. The method of any one of embodiments 46 to 48, wherein said removing second material from the replicated structure comprises machining at least a portion of the outlet face of the replicated structure.

It should be understood that although the exemplary methods are described as “comprising” one or more components, features or steps, the methods may “comprise,” “consists of,” or “consist essentially of any of the above-described components and/or features and/or steps. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of or “consisting of or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a method that “comprises” a list of elements (e.g., components or features or steps) is not necessarily limited to only those elements (or components or features or steps), but may include other elements (or components or features or steps) not expressly listed or inherent to the method.

As used herein, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

Further, the term “comprises” and variations thereof do not have a limiting meaning where these terms appear in the accompanying description. Moreover, “a,” “an,” “the,” “at least one,” and “one or more” are used interchangeably herein.

As used herein, the transitional phrases “consists of and “consisting of exclude any element, step, or component not specified. For example, “consists of or “consisting of used in a claim would limit the claim to the components, materials or steps specifically recited in the claim except for impurities ordinarily associated therewith (i.e., impurities within a given component). When the phrase “consists of or “consisting of appears in a clause of the body of a claim, rather than immediately following the preamble, the phrase “consists of or “consisting of limits only the elements (or components or steps) set forth in that clause; other elements (or components) are not excluded from the claim as a whole.

As used herein, the transitional phrases “consists essentially of and “consisting essentially of are used to define a method that includes materials, steps, features, components, or elements, in addition to those literally disclosed, provided that these additional materials, steps, features, components, or elements do not materially affect the basic and novel characteristic(s) of the claimed invention. The term “consisting essentially of occupies a middle ground between “comprising” and “consisting of. Further, it should be understood that the herein-described methods may comprise, consist essentially of, or consist of any of the herein-described components and features, as shown in the figures with or without any additional feature(s) not shown in the figures. In other words, in some embodiments, the methods of the present invention may have any additional feature that is not specifically shown in the figures. In some embodiments, the methods of the present invention do not have any additional features other than those (i.e., some or all) shown in the figures, and such additional features, not shown in the figures, are specifically excluded from the methods.

The complete disclosure of the patents, patent applications, patent documents, and publications identified herein are incorporated by reference in their entirety as if each were individually incorporated. To the extent there is a conflict or discrepancy between this document and the disclosure in any such incorporated document, this document will control.

From the above disclosure of the general principles of the present invention and the preceding detailed description, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof. In addition, it is understood to be within the scope of the present invention that the disclosed and claimed methods may be useful in other applications (i.e., in the manufacturing of articles other than fuel injector nozzle plates). Therefore, the scope of the invention may be broadened to include the use of the claimed and disclosed methods for such other applications.

1. A method of fabricating a nozzle structure, the method comprising:
forming a microstructured pattern on at least a portion of a three-dimensional structured surface by multi-photon processing a first material;
replicating a negative of the microstructured pattern and at least a portion of the three dimensional structured surface using a second material, different than the first material, to form a replicated structure having a negative pattern of the microstructured pattern and a negative surface of at least a portion of the three dimensional structured surface, wherein the negative of the portion of the three-dimensional structured surface replicated in the second material forms at least part of a cavity of the nozzle structure;
separating the replicated structure from the microstructured pattern and three-dimensional structured surface.

2. The method of claim 1, wherein the method further comprises removing second material from the replicated structure, after said replicating and either before or after said separating.

3. The method of claim 2, wherein said removing second material from the replicated structure occurs after the replicated structure is separated from the three-dimensional structured surface.

4. The method of claim 1, wherein the three-dimensional structured surface is located on a bottom of a cavity defined by a substrate, and wherein the first material is located in the cavity before multi-photon processing the first material.

5. The method of claim 1, wherein the three-dimensional structured surface comprises two discrete ruled surfaces, and at least a portion of the microstructured pattern is formed on the two discrete ruled surfaces.

6. The method of claim 1, wherein the three-dimensional structured surface is electrically conductive.

7. The method of claim 1, wherein the three-dimensional structured surface is located on a bottom of a cavity defined by a substrate, and the three-dimensional structured surface comprises an insert provided as a separate and discrete article located on a support surface of the substrate.

8. The method of claim 7, wherein the support surface does not form a portion of the three-dimensional structured surface.

9. The method of claim 7, wherein the insert is submerged in the first material before said forming a microstructured pattern.

10. The method of claim 7, wherein said separating the replicated structure from the three-dimensional structured surface comprises removing the insert.

11. The method of claim 1, wherein the three-dimensional structured surface comprises at least a portion of a fuel injector valve.

12. The method of claim 1 wherein the microstructured pattern comprises a plurality of microstructured features, and each microstructured feature is formed on the three-dimensional structured surface.

13. The method of claim 12, wherein each microstructured feature of the plurality of microstructured features comprises a base formed on the three-dimensional structured surface and a distal end distal from the three-dimensional structured surface, and the microstructured pattern optionally comprises at least one support feature attached to the distal ends of at least two of the plurality of microstructured features so as to provide additional structural integrity to microstructured features.

14. The method of claim 1, wherein said replicating comprises electroplating the three-dimensional structured surface such that the microstructured pattern is contained within the second material.

15. The method of claim 1, wherein, after said replicating, a portion of the second material is removed from the replicated structure so that the microstructured pattern defines a plurality of through-holes extending through the replicated structure from an inlet face of the replicated structure to an outlet face of the replicated structure.
